(19) United States
(12) Patent Application Publication
(10) Pub. No.: US 2024/0353848 A1
(43) Pub. Date: Oct. 24, 2024

(54) OPERATION DEVICE AND MOBILE ROBOT

(71) Applicant: TOYOTA JIDOSHA KABUSHIKI KAISHA, Toyota-shi (JP)

(72) Inventors: Takumi SAKAMOTO, Toyota-shi (JP); Shiro Oda, Anjo-shi (JP); Takeshi Matsui, Nisshin-shi (JP)

(73) Assignee: TOYOTA JIDOSHA KABUSHIKI KAISHA, Toyota-shi (JP)

(21) Appl. No.: 18/594,040

(22) Filed: Mar. 4, 2024

(30) Foreign Application Priority Data
Apr. 19, 2023 (JP) 2023-068266

(51) Int. Cl. G05D 1/223; G06F 3/0338

(52) U.S. Cl. CPC G05D 1/223; G06F 3/0338

(57) ABSTRACT

An operation device according to the present disclosure includes: an operation unit configured to receive an operation including a direction operation for a mobile robot; and a light emitting unit configured to emit light in a light emission pattern that indicates the state of the mobile robot.

### CROSS-REFERENCE TO RELATED APPLICATION

This application claims priority to Japanese Patent Application No. 2023-068266 filed on Apr. 19, 2023, incorporated herein by reference in its entirety.

### BACKGROUND

### 1. Technical Field

The present disclosure relates to an operation device and a mobile robot.

### 2. Description of Related Art

Japanese Patent No. 6171541 discloses an autonomous mobile body capable of switching between an autonomous travel mode and a manual travel mode.

### SUMMARY

The present inventor has studied a configuration in which a mobile robot can be operated using an operation device such as a joystick device. However, such a configuration involves an issue that the state of the mobile robot cannot be visually recognized by people in the surroundings when the operation device is used. With the technology described in Japanese Patent No. 6171541, the state of the autonomous mobile body cannot be visually recognized by people in the surroundings, and it is difficult to address the above issue, although a manual operation can be performed in the manual travel mode.

The present disclosure provides an operation device that renders a mobile robot operable and enables people in the surroundings to visually recognize the state of the mobile robot, and a mobile robot that includes the operation device.

An aspect of the present disclosure provides an operation device including: an operation unit configured to receive an operation including a direction operation for a mobile robot; and a light emitting unit configured to emit light in a light emission pattern that indicates a state of the mobile robot. With such a configuration, the operation device can render the mobile robot operable, and allow people in the surroundings to visually recognize the state of the mobile robot. The mobile robot can be controlled for autonomous movement. In the control for autonomous movement, the mobile robot can be autonomously moved using a learning model obtained through machine learning.

The light emitting unit may be provided around the operation unit. With such a configuration, the operation device can allow an operator to visually recognize the state of the mobile robot easily.

The operation device may be a joystick device that includes a stick member as at least a part of the operation unit. With such a configuration, the operation device can render the mobile robot easily operable, and allow people in the surroundings to visually recognize the state of the mobile robot.

The light emitting unit may be provided at a distal end of the stick member. With such a configuration, the joystick device can allow the operator to visually recognize the state of the mobile robot easily.

The operation device may be included in the mobile robot. With such a configuration, the operation device can allow people in the surroundings to visually recognize the state of the mobile robot also when the operation device is provided in the mobile robot.

Another aspect of the present disclosure provides a mobile robot including the operation device. The mobile robot is configured to receive an operation to move the mobile robot using the operation unit. The mobile robot includes an operation device that receives an operation to move the mobile robot, and the operation device can allow people in the surroundings to visually recognize the state of the mobile robot.

According to the present disclosure, it is possible to provide an operation device that renders a mobile robot operable and enables people in the surroundings to visually recognize the state of the mobile robot, and a mobile robot that includes the operation device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating an example of the overall configuration of a mobile robot according to an embodiment;

FIG. 2 is a perspective view illustrating an example of the overall configuration of a wagon transported by the mobile robot in FIG. 1;

FIG. 3 is a perspective view illustrating how the mobile robot in FIG. 1 transports the wagon in FIG. 2;

FIG. 4 is a flowchart illustrating an example of a light emission process executed by the mobile robot in FIG. 1;

FIG. 5 illustrates an example of light emission patterns that can be implemented by the mobile robot in FIG. 1;

FIG. 6 is a flowchart illustrating another example of the light emission process executed by the mobile robot in FIG. 1;

FIG. 7 illustrates another example of the light emission patterns that can be implemented by the mobile robot in FIG. 1;

FIG. 8 is a schematic diagram illustrating an example of the overall configuration of a system including the mobile robot according to the embodiment;

FIG. 9 is a flowchart illustrating an example of a process by a higher-level management device in the system in FIG. 8;

FIG. 10 is a perspective view illustrating another example of the configuration of an operation device that can be used to operate the mobile robot according to the embodiment; and

FIG. 11 illustrates an example of the hardware configuration of an apparatus.

### DETAILED DESCRIPTION OF EMBODIMENTS

While the present disclosure will be described below by way of an embodiment, the present disclosure is not limited to the following embodiment. All the components described in relation to the embodiment are not necessarily essential as means for addressing the issue.

### Embodiment

An operation device according to the present embodiment is used to operate a mobile robot. The operation device includes an operation unit that receives an operation including a direction operation for the mobile robot. This mobile robot can be a robot that is autonomously movable. Therefore, while an autonomously movable robot is mentioned as an example of the mobile robot, it is only necessary that the mobile robot should at least be configured to be operable by the operation device, and may not be autonomously movable.

The configuration of a joystick device and the operation of the mobile robot performed using the joystick device will be described while using the joystick device as an example of the operation device according to the present embodiment and using a system including the autonomously movable mobile robot as an example. The system includes a control system that executes system control for controlling the system. The mobile robot is configured to be able to transport a transport object. While a mobile robot configured to be able to transport a transport object is described as an example below, the mobile robot may be configured not to be able to transport a transport object. When the mobile robot is configured to be able to transport a transport object, the mobile robot can also be referred to as a transport robot, and the above system can be referred to as a transport system.

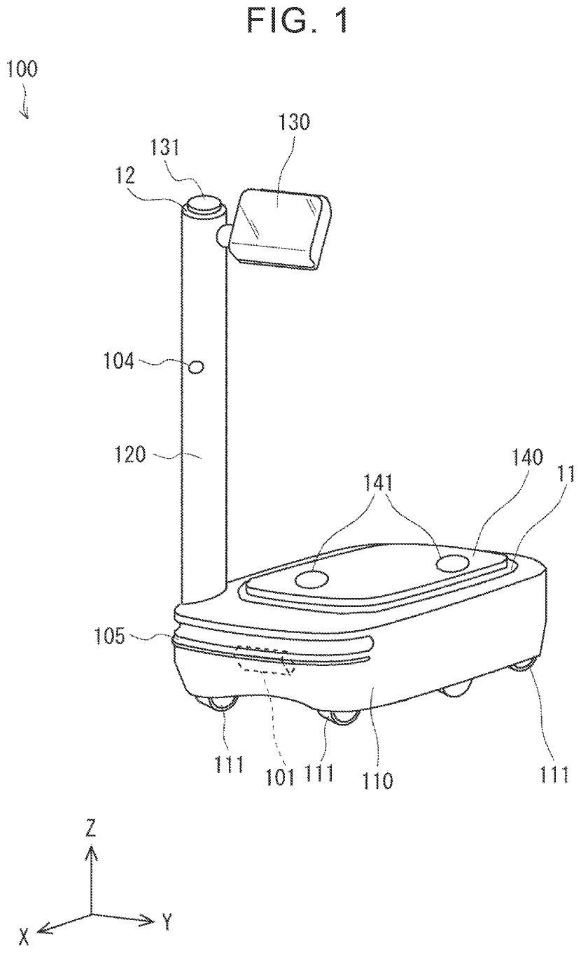

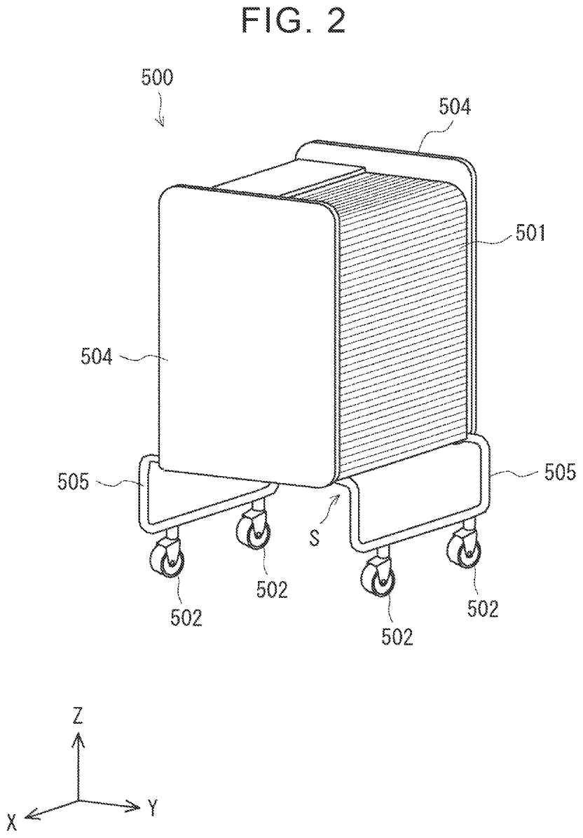

An example of the configuration of a mobile robot according to the present embodiment will be described below with reference to FIGS. 1 and 2. FIG. 1 is a perspective view illustrating an example of the overall configuration of a mobile robot according to the present embodiment. FIG. 2 is a perspective view illustrating an example of the overall configuration of a wagon transported by the mobile robot in FIG. 1.

While it is only necessary that the above system such as the transport system should include a mobile robot such as a mobile robot 100 illustrated in FIG. 1, the system may also include other devices such as a higher-level management device. For simplicity of description, however, an example in which the transport system is mainly composed of the mobile robot 100 will first be described. In this example, the control system can indicate either the mobile robot 100 itself or constituent elements of a control system included in the mobile robot 100.

In the following description, an XYZ orthogonal coordinate system will be used as appropriate. An X direction is a front-rear direction of the mobile robot 100 illustrated in FIG. 1, a Y direction is a right-left direction, and a Z direction is a vertical up-down direction. More specifically, a +X direction is defined as a forward direction of the mobile robot 100, and a-X direction is defined as a rearward direction of the mobile robot 100. A +Y direction is a leftward direction of the mobile robot 100, and a-Y direction is a rightward direction of the mobile robot 100. A +Z direction is a vertically upward direction, and a-Z direction is a vertically downward direction.

The mobile robot 100 is movable in both the forward and rearward directions. That is, the mobile robot 100 moves in the forward direction when its wheels are rotated forward, and moves in the rearward direction when the wheels are rotated in reverse. Rendering the respective rotational speeds of the right and left wheels different allows the mobile robot 100 to turn right or left.

10 As illustrated in FIG. 1, the mobile robot 100 can include a platform 110 on which a transport object is to be mounted, a stand 120, and an operation unit 130. The platform 110 is equipped with wheels 111, axles, a battery, a control computer 101, a drive motor, etc. While it is assumed in the description that the control computer 101 is mounted at an illustrated position of the platform 110, this is not limiting, and the control computer 101 may be mounted at a different position of the platform 110. A part or all of the control 15 computer 101 may be mounted on at least one of the stand 120 and the operation unit 130.

The platform 110 rotatably holds the wheels 111. In the example in FIG. 1, the platform 110 is provided with four wheels 111. The four wheels 111 are right and left front wheels and right and left rear wheels. The mobile robot 100 moves along a desired 20 route by independently controlling the rotational directions and the rotational speeds of the wheels 111. Some of the four wheels 111 may be drive wheels, and the rest of the wheels 111 may be driven wheels. As illustrated in FIG. 1, additional driven wheels may be provided between the front and rear wheels 111.

In order to suppress contact with an obstacle or check the route, for example, various sensors such as a camera and a distance sensor may be provided in at least one of the platform 110, the operation unit 130, and the stand 120.

FIG. 1 illustrates an example in which a camera 104 and a sensor 105 are provided as such sensors. The camera 104 is provided in the stand 120, and directed to the +X side. The sensor 105 is provided on the front side of the platform 110. A bumper may be 30 provided on the front side of the platform 110. The sensor 105 may be disposed on the bumper to detect contact of the bumper with an object. The mobile robot 100 can be controlled so as to be stopped when the sensor 105 detects contact with an object, that is, an obstacle. Hence, the sensor 105 can be referred to as a stop sensor. However, it is not necessary that the sensor 105 should be mounted on the front side, and the sensor 105 may be a sensor that detects contact of an object with a bumper provided at a part or all of the outer periphery of the mobile robot 100. The sensor 105 may also be configured to detect the position of contact of an object with the bumper on which the sensor 105 is provided.

While the mobile robot 100 is an autonomous mobile robot, the mobile robot 100 is equipped with a function to move according to operations by a user. That is, the mobile robot 100 is a mobile robot configured to switch between an autonomous travel mode and a user operation mode. By the control for autonomous movement, the mobile robot 100 can move autonomously based on a route determined according to a set transport destination or a set route. In the control for autonomous movement, the mobile robot 100 can be autonomously moved by determining a route, avoiding contact, etc. using a learning model obtained through machine learning.

Here, it is only necessary that the user operation mode in which the mobile robot is moved based on user operations should be a mode in which the degree of involvement of user operations is relatively high compared to the autonomous travel mode in which the mobile robot is autonomously moved. That is, the user operation mode is not necessarily limited to a mode in which every motion of the mobile robot is operated by a user and the mobile robot is not autonomously controlled at all. The autonomous travel mode is not necessarily limited to a mode in which the mobile robot is completely autonomously controlled and no user operations are received. For example, the user operation mode and the autonomous travel mode may include the following first to third examples.

In a first example, in the autonomous travel mode, the mobile robot autonomously travels and makes determinations as to stopping and starting to travel, and the user do not perform operations. In the first example, in the user operation mode, the mobile robot autonomously travels, and the user performs operations to stop and start to travel. In a second example, in the autonomous travel mode, the mobile robot autonomously travels, and the user performs operations to stop and start to travel. In the second example, in the user operation mode, the mobile robot does not autonomously travel, and the user performs not only operations to stop and start to travel but also operations to travel. In a third example, in the autonomous travel mode, the mobile robot autonomously travels and makes determinations as to stopping and starting to travel, and the user do not perform operations.

In the third example, in the user operation mode, the mobile robot autonomously travels for speed adjustment, contact avoidance, etc., and the user performs operations to change the travel direction, route, etc.

The user may be a worker etc. at a facility at which the mobile robot 100 is in operation, and may be a hospital worker when the facility is a hospital.

The control computer 101 can be implemented by an integrated circuit, for example. For example, the control computer 101 can be implemented by a processor such as a micro processor unit (MPU) or a central processing unit (CPU), a working memory, a non-volatile storage device, etc. The function to control the mobile robot 100 can be achieved by the storage device storing a control program to be executed by the processor and the processor loading the program into the working memory and executing the program. The control computer 101 can be referred to as a control unit.

The control computer 101 controls autonomous movement of the mobile robot 100 such that the mobile robot 100 moves toward a transport destination set in advance or moves along a transport route set in advance based on map data stored in advance and information acquired by various sensors exemplified by the camera 104. This autonomous movement control can include control for mounting a wagon 500 illustrated in FIG. 2 and control for unmounting the wagon 500. The wagon 500 will be discussed later. The control computer 101 can include a movement control unit that performs such autonomous movement control.

In order to load and unload a transport object such as the wagon 500, the platform 110 can include an elevation mechanism 140 for loading and unloading the transport object. A part of the elevation mechanism 140 can be housed inside the platform 110. The elevation mechanism 140 can be disposed with a placement surface for placement of the transport object exposed to the upper surface side of the platform 110. The elevation mechanism 140 can be an elevation stage provided to be elevatable, and can be elevated and lowered according to control by the control computer 101. The platform 110 is provided with a motor and a guide mechanism for elevation. The upper surface of the elevation mechanism 140 serves as a placement surface for placement of the wagon 500 as a transport object. The wagon 500 is not limited to the configuration illustrated in FIG. 2, and may be any wagon with predetermined size, shape, and weight that can be placed on the elevation mechanism 140 to be transported. The elevation mechanism 140 includes a lift mechanism that lifts the wagon 500. A space above the elevation mechanism 140 serves as a mounting space for mounting of the transport object. The platform 110 may not include the elevation mechanism 140 if the mobile robot 100 is limited to operation in which the user loads the wagon 500.

The platform 110 can include a first light emitting unit 11 provided at a position around the elevation mechanism 140. It is only necessary that the first light emitting unit 11 should be configured to emit light. For example, the first light emitting unit 11 can be composed of one or more light-emitting diodes (LEDs), organic electro-luminescence elements, etc. Light emission by the first light emitting unit 11 can be controlled by the control computer 101. The position, shape, and size of the first light emitting unit 11 are not limited to those illustrated in the drawings. The mobile robot 100 can include the first light emitting unit 11 also when the elevation mechanism 140 is not provided. The first light emitting unit 11 and a second light emitting unit 12 to be discussed later are given the prefixes “first” and “second” just in order to distinguish them.

The stand 120 is attached to the platform 110. The stand 120 is a rod-shaped member that extends upward from the platform 110. While the stand 120 is formed in the shape of a circular column, the longitudinal direction of which is the Z direction, the stand 120 may have any shape, or the mobile robot 100 may not be configured to include the stand 120, as a matter of course. The longitudinal direction of the stand 120 is parallel to the Z direction. The stand 120 is disposed outside the elevation mechanism 140. That is, the stand 120 is disposed so as not to interfere with elevating operation of the elevation mechanism 140. The stand 120 is disposed on one end side of the platform 110 in the Y direction (right-left direction). The stand 120 is attached in the vicinity of the front right corner portion of the platform 110. The stand 120 is provided at an end portion of the platform 110 on the +X side and the-Y side in the XY plane.

The stand 120 can include a stick portion (stick member) 131, as a constituent element of a joystick device according to the present embodiment, provided on the upper surface portion of the stand 120. The joystick device is a device that allows performing an operation to move the mobile robot 100 in a direction intended by the user when in the user operation mode. This moving operation can be received by the stick portion 131. The stick portion 131 can be grasped by a hand of the user, and therefore can be referred to as a grip portion. The shape and size of the stick portion 131 are not limited to those illustrated in the drawings. For example, the stick portion 131 may be shaped to be elongated in the Z-axis direction. As a matter of course, the shape and size of the joystick device including the stick portion 131 are also not limited to those illustrated in the drawings.

A direction operation can be received when the user tilts the stick portion

131 in a direction in which the user desires to move the mobile robot 100. The joystick device can be controlled such that a switching operation to switch between the autonomous travel mode and the user operation mode is performed by depressing the stick portion 131 downward. Alternatively, the joystick device can be controlled such that a determination operation is performed by depressing the stick portion 131 downward. The stick portion 131 can also be configured to function as an emergency stop button for urgently stopping the mobile robot 100 by depressing the stick portion 131 downward for a predetermined period. When the stick portion 131 is configured to be able to receive two or more of the switching operation, the determination operation, and the emergency stop operation, this predetermined period may be rendered different among such operations.

The stand 120 can include a second light emitting unit 12 provided at a position around the stick portion 131. It is only necessary that the second light emitting unit 12 should be configured to emit light. For example, the second light emitting unit 12 can be composed of one or more LEDs, organic electro-luminescence elements, etc. Light emission by the second light emitting unit 12 can be controlled by the control computer 101. The position, shape, and size of the second light emitting unit 12 are not limited to those illustrated in the drawings. The mobile robot 100 can include the second light emitting unit 12 also when the stand 120 is not provided or when the stand 120 is provided but the stick portion 131 is not provided.

The stand 120 supports the operation unit 130. The operation unit 130 is

attached in the vicinity of the upper end of the stand 120. This allows the operation unit 130 to be installed at a height at which the operation unit 130 is easily operable by the user. That is, the stand 120 extends to a height at which the user standing can perform operations easily, and the stick portion 131 is also disposed at a height at which the user can perform operations easily. The operation unit 130 extends toward the +Y side from the stand 120.

From the viewpoint of easy operability, the operation unit 130 can be disposed at the center of the platform 110 in the right-left direction.

The operation unit 130 can include a touch panel monitor etc. that receives operations by the user. As a matter of course, the operation unit 130 can include a microphone etc. for audio input. The monitor of the operation unit 130 is directed to the opposite side of the platform 110. That is, a display surface (operation surface) of the operation unit 130 is a surface on the +X side. The operation unit 130 may be provided to be detachable from the stand 120. That is, a holder that holds a touch panel may be attached to the stand 120. The user can input a transport destination for a transport object, transport information about the transported object, etc. by operating the operation unit 130. Further, the operation unit 130 can display information such as the content of the transport object, the transport object expected to be transported, and the destination to the user during transport. As a matter of course, the mobile robot 100 may not be configured to include the operation unit 130. Also in that case, operations can be performed in the user operation mode using the joystick device. The mobile robot 100 can also be connected to a remote operation device that is used to perform remote operations. This remote operation device can also be a joystick device.

As illustrated in the drawings, the operation unit 130 and the stick portion 131 can be disposed at at least about the same height so that operations can be performed intuitively. This allows the user to perform operations intuitively even when an operation to depress the stick portion 131 is assigned to an operation to determine an operation content displayed on the operation unit 130.

An integrated circuit (IC) card reader that allows the user to perform user authentication using an IC card etc. can be provided at a position on the stand 120 at about the same height as the operation unit 130 or inside the operation unit 130. While it is not necessary that the mobile robot 100 should be provided with a user authentication function, providing the user authentication function can block mischievous operations by a third party etc. The user authentication function is not limited to one that uses an IC card, and may employ a method including inputting user information and a password using the operation unit 130. Trouble for the user can be reduced and infection can be suppressed by implementing the user authentication function using a variety of short-range wireless communication technologies that enable contactless authentication.

The user can place the transport object in the wagon 500 placed on the mobile robot 100 described above, and request the mobile robot 100 to transport the transport object. The wagon 500 itself can also be referred to as a transport object. Therefore, for convenience, the transport object placed in the wagon 500 will be referred to as an article for distinction in the following description. The mobile robot 100 autonomously moves to a set destination to transport the wagon 500. That is, the mobile robot 100 executes a task of transporting the wagon 500. In the following description, a location at which the wagon 500 is mounted will be referred to as a transport origin or a loading location, and a location to which the wagon 500 is delivered will be referred to as a transport destination or a destination.

For example, it is assumed that the mobile robot 100 moves in a general hospital with a plurality of clinical departments. The mobile robot 100 transports articles such as supplies, consumables, and medical instruments among the clinical departments. For example, the mobile robot 100 delivers articles from a nurse station of a certain clinical department to a nurse station of another clinical department. Alternatively, the mobile robot 100 delivers articles from a storage for supplies and medical instruments to a nurse station of a clinical department. The mobile robot 100 also delivers medicine dispensed in a dispensing department to a clinical department or a patient expected to use the medicine.

Examples of the articles include drugs, consumables such as bandages, specimens, inspection instruments, medical instruments, hospital diets, and supplies such as stationery. Examples of the medical instruments include sphygmomanometers, blood transfusion pumps, syringe pumps, foot pumps, nurse call buttons, bed leaving sensors, low-pressure continuous inhalers, electrocardiogram monitors, drug injection controllers, enteral nutrition pumps, artificial respirators, cuff pressure gauges, touch sensors, aspirators, nebulizers, pulse oximeters, artificial resuscitators, aseptic devices, and echo machines. Meals such as hospital diets and inspection diets may also be transported. The mobile robot 100 may further transport instruments that have been used, tableware that has been used, etc. When the transport destination is on a different floor, the mobile robot 100 may move using an elevator etc.

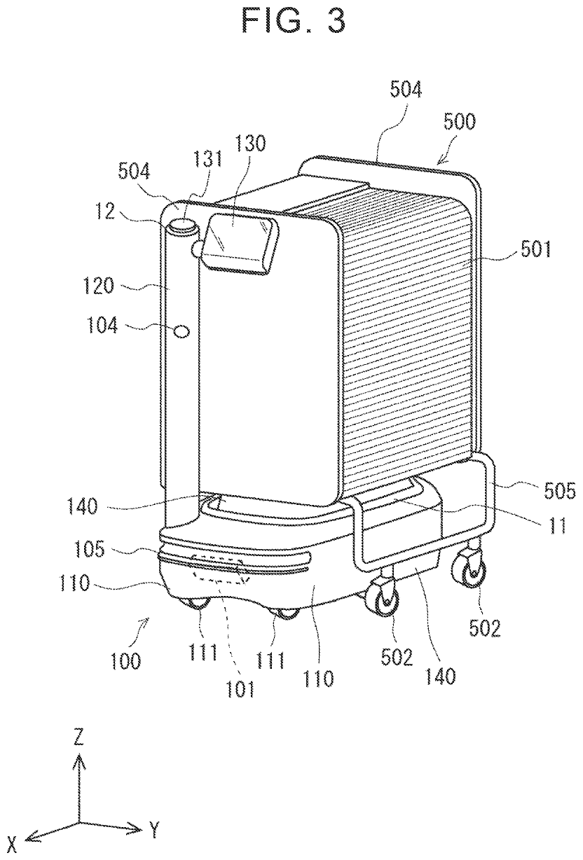

Next, the details of the wagon 500 and an example of how the mobile robot 100 holds the wagon 500 will be described with reference to FIGS. 2 and 3. FIG. 3 is a perspective view illustrating how the mobile robot 100 transports the wagon 500.

The wagon 500 includes a housing portion that houses an article, and a support portion that supports the housing portion with a space formed under the housing portion to allow insertion of at least a part of the platform 110. As illustrated in FIG. 2, the housing portion can be configured to include side plates 504 on both sides of the wagon 500 and an openable cover 501. When the user opens the cover 501, the article housed inside the wagon 500 can be unloaded. As illustrated in FIG. 2, the support portion can be configured to include support frames 505 that support the housing portion, and wheels 502 attached under the support frames 505. The wheels 502 can include covers (not illustrated).

The wagon 500 can be held by the elevation mechanism 140 of the mobile robot 100 as discussed above. The elevation mechanism 140 is a mechanism that loads and unloads the wagon 500 as a transport object on and off the upper surface side of at least a part of the platform 110. The mobile robot 100 can automatically transport the wagon 500 easily by including the elevation mechanism 140.

As illustrated in FIG. 3, the mobile robot 100 can hold the wagon 500 using the elevation mechanism 140. The space to allow insertion of at least a part of the platform 110 discussed above is a space S formed under the wagon 500 illustrated in FIG. 2. The space S allows insertion of the platform 110. That is, the platform 110 can be inserted into the space S directly under the wagon 500. When the wagon 500 is mounted on the platform 110, the mobile robot 100 moves in the-X direction to be inserted into the space directly under the wagon 500. The platform 110 is inserted into the space directly under the wagon 500 from the side on which the stand 120 is not provided in the front-rear direction. In this manner, the wagon 500 can be mounted without the stand 120 interfering with the wagon 500. In other words, the stand 120 can be attached in the vicinity of a corner portion of the platform 110 so as not to interfere with the wagon 500.

As illustrated in FIG. 1, recessed portions 141 can be provided in a contact portion of the elevation mechanism 140 that contacts the bottom surface of the wagon 500 through coupling, connection, etc. when transporting the wagon 500 in a mounted state. The contact portion can be the upper surface of the elevation mechanism 140. On the other hand, projecting portions (not illustrated) can be provided on the lower side of the housing portion of the wagon 500. The wagon 500 can be fixed to the mobile robot 100 by fitting the projecting portions with the recessed portions 141.

While the wagon 500 is illustrated as a cart that includes the wheels 502, the shape and configuration of the wagon 500 are not specifically limited. It is only necessary that the predetermined wagon exemplified by the wagon 500 should have a shape, size, and weight that enable the wagon to be transported by the mobile robot 100.

Operation of the mobile robot 100 to load the wagon 500, transport the wagon 500 to a transport destination, and unload the wagon 500 will be described. First, to load the wagon 500, the mobile robot 100 can be determined as a mobile robot that is set in advance to transport the wagon 500 and that moves in search of the wagon 500 or to an existing position. For example, the mobile robot 100 can autonomously move to transport the wagon 500 with the wagon 500, the position of which is specified by the user, specified as a target to be transported or searched for. Alternatively, the mobile robot 100 may automatically transport the wagon 500 to a transport destination when the wagon 500 is found on the way back after finishing a transport task of transporting a different wagon or an article etc. These examples are not limiting, and various methods can be applied as the method of operation for the mobile robot 100 to transport the wagon 500.

The mobile robot 100 moves to the position of the wagon 500, and the control computer 101 performs control so as to recognize the wagon 500 based on information acquired by the camera 104 or another sensor and load the wagon 500 using the elevation mechanism 140. This control for the loading can also be referred to as pick-up control.

In the pick-up control, first, the platform 110 is inserted into the space S

directly under the wagon 500, and the elevation mechanism 140 is elevated when the insertion is completed. This allows the elevation mechanism 140 to lift the wagon 500 with the elevation stage, as the upper surface of the elevation mechanism 140, in contact with the wagon 500. That is, when the elevation mechanism 140 is elevated, the wagon 500 is mounted on the platform 110 with the wheels 502 brought off the ground. This renders the mobile robot 100 ready to dock with the wagon 500 and move toward the transport destination. Next, the wagon 500 is transported to the transport destination by the control computer 101 controlling drive of the wheels 111 etc. so as to autonomously move along a set route.

The mobile robot 100 moves to the transport destination for the wagon 500, and the control computer 101 performs control so as to unmount the wagon 500 using the elevation mechanism 140. In this control, the elevation mechanism 140 is lowered in order to unmount the wagon 500 from the platform 110. The wheels 502 are brought into contact with the floor surface, and the upper surface of the elevation mechanism 140 is brought off the wagon 500. The wagon 500 is placed on the floor surface. The wagon 500 can be unmounted from the platform 110.

The above various examples have been described on the assumption that the mobile robot 100 transports a wagon such as the wagon 500 as a transport object. However, the mobile robot 100 may transport an individual article (load) as a transport object during operation, even if the mobile robot 100 is configured to be able to transport a wagon. In that case, a housing box, a shelf portion, etc. that does not allow the article to fall during movement is preferably attached to the mobile robot 100.

In operation, there may be a scene in which the mobile robot 100 transports a plurality of articles and it is necessary to transport the articles to a plurality of transport destinations. In this case, the user can unload the articles at the transport destinations, irrespective of whether the wagon 500 is used for transport. The mobile robot 100 can autonomously move, or move according to user operations, to a set destination and transport the wagon or the individual articles.

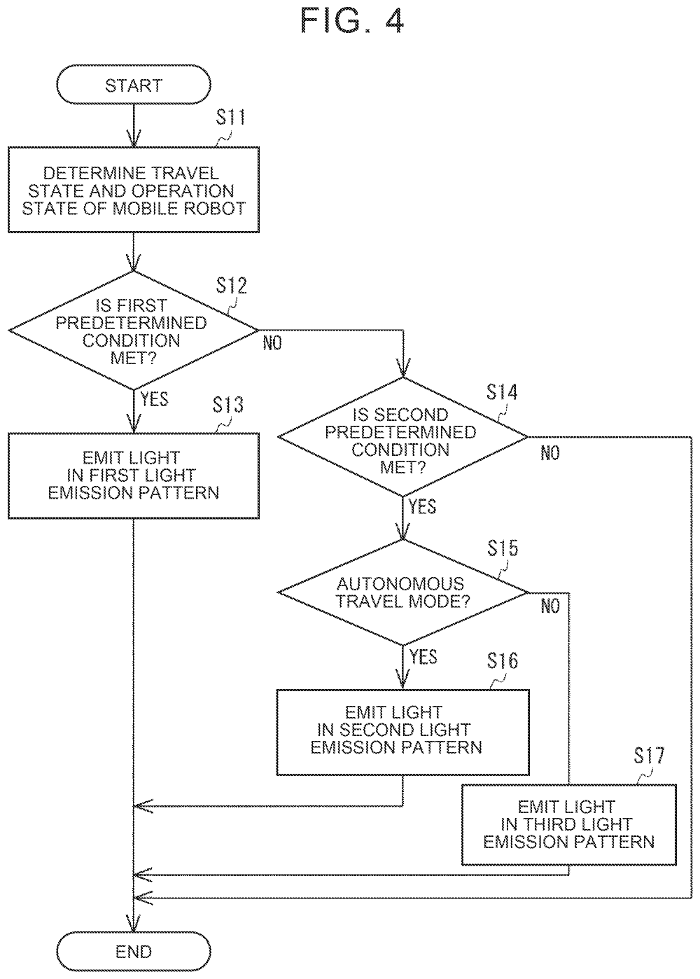

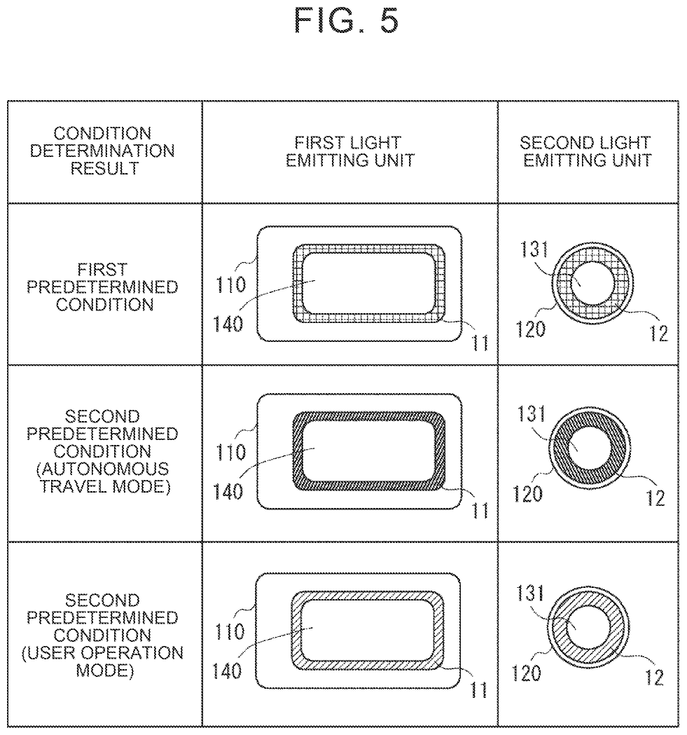

Next, an example of main features of the present embodiment will be described with reference to FIGS. 4 and 5. FIG. 4 is a flowchart illustrating an example of a light emission process executed by the mobile robot 100. FIG. 5 illustrates an example of light emission patterns that can be implemented by the mobile robot 100.

The mobile robot 100 can include a joystick device as a main feature of the present embodiment. The joystick device includes a stick portion (stick member) 131 that receives an operation including a direction operation for the mobile robot 100 as discussed above, and a second light emitting unit 12. The second light emitting unit 12 is an example of a light emitting unit included in the joystick device to emit light in a light emission pattern that indicates the state of the mobile robot 100.

The direction operation also includes an operation to move the mobile robot 100. While the mobile robot 100 includes a joystick device in the described example, the mobile robot 100 may not include a joystick device. A configuration in which the mobile robot 100 can be subjected to a direction operation performed from a joystick device included in an object other than the mobile robot 100 is also possible.

While the second light emitting unit 12 is provided around the stick member 131 in the example, this is not limiting, and the second light emitting unit 12 may be provided at the distal end of the stick member 131. Whichever arrangement is employed, the joystick device can allow the operator to visually recognize the state of the mobile robot 100 easily.

The control computer 101 executes, as a part of the system control discussed above, light emission control in which the second light emitting unit 12 is caused to emit light in a light emission pattern that indicates the state of the mobile robot 100. The light emission pattern can also be referred to as a light emission mode.

The state of the mobile robot 100 can be at least one of a travel state associated with the travel environment of the mobile robot 100 and an operation state of the mobile robot 100, for example. The travel state can indicate whether a travel abnormality associated with the travel environment such as contact with a wall is caused in the mobile robot 100, for example. The operation state is described as indicating a state other than the state of the travel mode, whether the mobile robot 100 is in the autonomous travel mode or the user operation mode, for convenience. The operation state is described as indicating whether there is any operation abnormality, or as indicating the content of the operation abnormality. Here, the operation abnormality can indicate abnormalities excluding abnormalities in the travel state associated with the travel environment of the mobile robot 100, and indicate various abnormalities such as a dead battery, an abnormality in a drive unit, and an abnormality in the wheels, for example, of the mobile robot 100.

The above light emission control can be mainly control for light emission in different light emission patterns correlated with a plurality of predetermined conditions about the state of the mobile robot 100, for example. Here, it is only necessary that the predetermined conditions should include at least conditions about the state of the mobile robot 100. The predetermined conditions include at least one of a condition about the travel state of the mobile robot 100 and a condition about the operation state of the mobile robot 100, for example. The mobile robot 100 can also be configured to detect the occurrence of an earthquake, a fire, etc. through external communication or using a sensor included in the mobile robot 100. In such a configuration, the predetermined conditions may also include the presence or absence of an earthquake or the presence or absence of a fire. The correlation between the predetermined conditions and the light emission patterns can be stored as a table etc. in a storage unit inside the control computer 101, for example, to be referenced when necessary.

The above light emission control can also be control in which the second light emitting unit 12 and the first light emitting unit 11 are caused to emit light in different light emission patterns correlated with the predetermined conditions. An example in which the mobile robot 100 includes light emitting units provided at two locations to express different light emission patterns will be described below. However, it is only necessary that the mobile robot 100 should include at least a light emitting unit exemplified by the second light emitting unit 12 included in the joystick device, and the second light emitting unit 12 alone can express different light emission patterns.

It is only necessary that the mobile robot 100 should include a light emitting unit exemplified by the second light emitting unit 12, and light emitting units may be provided at a total of three or more locations. The arrangement position of the light emitting units and the shape and size of the light emitting units are also not limited to those exemplified. From the viewpoint of visibility from the surroundings, however, the light emitting units are preferably disposed at a plurality of positions spaced from each other as exemplified by the positional relationship between the second light emitting unit 12 and the first light emitting unit 11.

The control computer 101 can also execute, as a part of the system control discussed above, mode switching control for switching between the autonomous travel mode and the user operation mode discussed above. Here, when a movement operation is received from the operation unit 130, a user interface that receives the operation using software can be displayed on the screen. While an example in which the mobile robot 100 includes a joystick device and the operation unit 130 as the operation unit is described, it is only necessary that the mobile robot 100 should include at least a joystick device that receives an operation to move the mobile robot 100. However, it is possible to perform an operation to switch between the autonomous travel mode and the user operation mode using the mobile robot 100 at hand by enabling either of the joystick device and the operation unit 130 to receive such a switching operation.

The control computer 101 can also perform, as at least a part of the light emission control discussed above, control for light emission in different light emission patterns according to whether the mobile robot 100 is in the autonomous travel mode or the user operation mode for at least one of the predetermined conditions.

In the joystick device according to the present embodiment, the second light emitting unit 12 is caused to emit light in a light emission pattern that matches the state of the mobile robot 100 as discussed above. Hence, this joystick device can render the mobile robot 100 operable, and allow people in the surroundings to visually recognize the state of the mobile robot 100. The people in the surroundings can include an operator (user) that performs operations using the joystick device, which allows the user to easily see the state of the mobile robot 100 at hand and easily operate the mobile robot 100.

As exemplified in FIG. 1, the mobile robot 100 includes a joystick device, and the stick member 131 receives an operation to move the mobile robot 100. This allows people in the surroundings to visually recognize the state of the mobile robot 100 using the joystick device.

In order for such control, the control computer 101 first determines the travel state of the mobile robot 100 based on the results of detections by sensors such as the sensor 105, and determines the operation state of the mobile robot 100, indicating the presence or absence of an operation abnormality (step S11). The travel state and the operation state may be determined in any order. Here, for the operation state, it is determined whether there is any operation abnormality, which of a battery, a drive unit, wheels, etc. is the location of the abnormality, etc., for example. This determination can be made by the control computer 101 based on the results of detections by various sensors provided in the mobile robot 100, for example.

Here, the determination of the travel state can be executed by the control computer 101 by performing information processing, image processing, etc. based on the results of detections by sensors such as the sensor 105, and will be described on the assumption that the determination is made in this manner. However, the sensors can also have a function to make a detection such that the result of the detection indicates the result of the determination of the travel state itself, or to determine the travel state by performing information processing, image processing, etc. based on the sensing results. In that case, the sensors transmit the determination result to the control computer 101, and the control computer 101 can use contents received from the sensors as the result of the determination of the travel state. The determination of the travel state can also be executed by a determination unit provided separately from the control computer 101 that performs light emission control.

As with the determination of the travel state, the determination of the operation state can be executed by the control computer 101 by performing information processing, image processing, etc. based on the results of detections by sensors such as the sensor 105, and will be described on the assumption that the determination is made in this manner. However, the sensors can also have a function to make a detection such that the result of the detection indicates the result of the determination of the operation state itself, or to determine the operation state by performing information processing, image processing, etc. based on the sensing results. In that case, the sensors transmit the result of the determination of the operation state to the control computer 101, and the control computer 101 can use contents received from the sensors as the result of the determination of the operation state. The determination of the operation state can also be executed by a determination unit provided separately from the control computer 101 that performs light emission control.

The mobile robot 100 can include a storage unit (not illustrated) that stores information indicating the thus acquired travel state and operation state in the control computer 101, for example. The control computer 101 can determine the travel state and the operation state based on the recently stored travel state and operation state, respectively.

Subsequent to step S11, the control computer 101 determines whether a first predetermined condition is met based on the determined travel state and operation state (step S12). The description is made on the assumption that the first predetermined condition is a condition that the mobile robot 100 is not abnormal but normal for both the travel state and the operation state for convenience.

When normal, the control computer 101 controls the first light emitting unit 11 and the second light emitting unit 12 so as to emit light in a first light emission pattern such as that exemplified by a “first predetermined condition” in FIG. 5 (step S13), for example, and ends the process.

When not normal, that is, when there is any abnormality in the travel state or the operation state, on the other hand, the control computer 101 determines whether a second predetermined condition is met (step S14). The description is made on the assumption that the second predetermined condition is a condition that the mobile robot 100 falls into a state of needing treatment if the mobile robot 100 continues to travel for one or both of the travel state and the operation state for convenience. When the second predetermined condition is met, the control computer 101 determines whether the mobile robot 100 is presently in the autonomous travel mode or the user operation mode (step S15). Information that indicates whether the mobile robot 100 is in the autonomous travel mode and the user operation mode can be obtained by referencing the present travel mode of the control computer 101.

When in the autonomous travel mode, the control computer 101 controls the first light emitting unit 11 and the second light emitting unit 12 so as to emit light in a second light emission pattern exemplified in a “second predetermined condition (autonomous travel mode)” in FIG. 5 (step S16), for example, and ends the process. When in the user operation mode, on the other hand, the control computer 101 controls the first light emitting unit 11 and the second light emitting unit 12 so as to emit light in a third light emission pattern exemplified in a “second predetermined condition (user operation mode)” in FIG. 5 (step S17), for example, and ends the process. As a matter of course, such a process can be repeatedly performed at predetermined intervals of determinations of the travel state and the operation state, or each time the results of detections by sensors that are used to determine the travel state and the operation state are varied, for example.

The first to third light emission patterns in this example can be determined such that the first light emission pattern is the most inconspicuous, the second light emission pattern is the most appealing to people in the surroundings, and the third light emission pattern is the most appealing to the operator, for example. The light emission patterns implemented in the light emission control can also include patterns in which the light emitting units are turned off, such as the first light emission pattern being determined as a pattern in which both the first light emitting unit 11 and the second light emitting unit 12 are turned off, for example. As discussed above, the light emission patterns employed such as the first to third light emission patterns and other light emission patterns to be discussed later can be referenced during the light emission control by being stored in the control computer 101 as a table etc., for example.

While the same light emission pattern is used as the first light emission pattern for both the autonomous travel mode and the user operation mode here, different light emission patterns may be used for these modes when the result of the determination in step S12 is YES. While the process is performed using only two predetermined conditions, namely the first predetermined condition and the second predetermined condition, in the example here, three or more predetermined conditions can be used for further classification, and different light emission patterns can be presented according to the predetermined conditions.

When an abnormality is indicated in either of the travel state and the operation state, the mobile robot 100 is often stopped, that is, standing by. Hence, the mobile robot 100 can allow people in the surroundings to easily determine which of the autonomous travel mode and the user operation mode the mobile robot 100 is stopped in by performing light emission control according to the autonomous travel mode and the user operation mode as discussed above. That is, the mobile robot 100 can allow people in the surroundings of the mobile robot 100 to visually recognize and easily determine whether the mobile robot 100 is standing by in the autonomous travel mode or standing by in the user operation mode when the mobile robot 100 is standing by. Here, the surroundings can include not only people that are present in the surroundings but also monitoring cameras to be discussed later as environment cameras, and it is considered that the environment cameras can capture images that indicate the travel state in an easily seeable manner. As can be understood from the above description, the first light emitting unit 11 and the second light emitting unit 12 can function as indicators that indicate which of the autonomous travel mode and the user operation mode the mobile robot 100 is in.

As discussed above, the first light emitting unit 11 is a light emitting unit disposed around a contact portion that may contact a transport object when the transport object is mounted and transported. That is, the light emitting unit is disposed in the mobile robot 100 in consideration of the location of mounting of the light emitting unit, as exemplified by the positional relationship between the first light emitting unit 11 and the elevation stage. The contact portion can also be referred to as a mounting surface. The first light emitting unit 11 is provided in a body of the mobile robot 100 and around the contact portion. The contact portion is a portion that contacts the transport object when transporting the transport object with the transport object mounted on the contact portion, and a portion that contacts the transport object only before transport of the transport object or in the middle of mounting of the transport object can be excluded from the contact portion, for example. The contact portion can be a contact portion that contacts the bottom surface of the transport object, for example, and hence a portion that contacts a side surface of the transport object can be excluded from the contact portion. As a matter of course, transport objects of various sizes and shapes can be assumed as the transport object. However, the contact portion that may contact the transport object can indicate a portion that can possibly be in the state of contacting the transport object during transport of the mounted object, such as the upper surface of the elevation mechanism 140. Hence, in the state in which the wagon 500 or another transport object is mounted and transported, light emitted from the first light emitting unit 11 can be visually recognized from at least obliquely above the mobile robot 100 or a lateral direction, for example. This allows the mobile robot 100 to be easily seeable from people in the surroundings even when a transport object is mounted, and to be further easily seeable when no transport object is mounted. Therefore, it is possible to indicate which of the predetermined conditions is met, which of the autonomous travel mode and the user operation mode the mobile robot 100 is in, etc. to people in the surroundings of the mobile robot 100 in an easily seeable manner. When light is emitted from the periphery of the contact portion and the wagon 500 is used for transport as in this example, the mobile robot 100 can be visually recognized from people in the surroundings better by forming the lower surface of the wagon 500 as a mirror surface.

As discussed above, the second light emitting unit 12 is a light emitting unit provided in or around the joystick device that is used to operate the mobile robot 100. In the mobile robot 100, a light emitting unit is disposed at a high position, which is an operation position, to be easily seeable from the operator or people in the surroundings, as exemplified by the second light emitting unit 12, in particular. This allows the mobile robot 100 to indicate which of the predetermined conditions is met, which of the autonomous travel mode and the user operation mode the mobile robot 100 is in, etc. to people in the surroundings in an easily seeable manner even from a direction from which the mount position is not easily seeable, depending on the transport object such as the wagon 500.

As discussed above, the mobile robot 100 can include a sensor 105 that detects contact of an object with the outer periphery of the mobile robot 100. In this case, the travel state is determined as follows. That is, when the sensor 105 is detecting that an object is in contact with the mobile robot 100, the control computer 101 determines the travel state as involving a travel abnormality. When the sensor 105 is not detecting that an object is in contact with the mobile robot 100, the control computer 101 determines the travel state as involving no travel abnormality. If a condition that such contact is occurring is added to at least one of the predetermined conditions, a light emission pattern that is different from the other light emission patterns can be used to present a case where the contact has taken place.

With such a configuration, the mobile robot 100 can indicate that the mobile robot 100 is in contact with an object to people in the surroundings in an easily seeable manner, and can also indicate to people in the surroundings in an easily seeable manner when such contact has been released. It is possible to protect the body of the mobile robot 100 and a contacting object using a bumper provided at the outer periphery of the mobile robot 100, by providing the mobile robot 100 with a sensor that detects contact of an object with the bumper such as the sensor 105. The determination of an abnormal state can be executed not only by the sensor 105, but also based on information from another sensor such as the camera 104 mounted on the mobile robot 100, for example.

The control for rendering the light emission patterns different, such as using the first light emission pattern and the second light emission pattern, can include control for rendering at least one of the luminance, hue, saturation, and lightness of light emitted by the light emitting units exemplified by the first light emitting unit 11 and the second light emitting unit 12. In an example in which the light emitting units are disposed at a plurality of positions spaced from each other as exemplified by the first light emitting unit 11 and the second light emitting unit 12, the control for rendering the light emission patterns different can include control for causing the first light emitting unit 11 and the second light emitting unit 12 to emit light using different light emission parameters. Here, the light emission parameters can be at least one of the luminance, hue, saturation, and lightness discussed above.

In an example in which the light emitting units are disposed at a plurality of positions spaced from each other as exemplified by the first light emitting unit 11 and the second light emitting unit 12, the control for rendering the light emission patterns different can include emitting light at different positions. Light can be emitted at all positions in a certain light emission pattern, and light can be turned off at all positions in another light emission pattern. For example, the control for rendering the light emission patterns different can include control for turning off one of the first light emitting unit 11 and the second light emitting unit 12 and causing the other to emit light, that is, control for turning on and off light emission.

In an example in which the light emitting units are disposed at a plurality of positions spaced from each other as exemplified by the first light emitting unit 11 and the second light emitting unit 12, rendering the light emission patterns different can also include emitting light synchronously at a plurality of different positions. With such a configuration, the mobile robot 100 can indicate the state of the mobile robot 100 to people in the surroundings in an easily seeable manner.

Examples of such light emission patterns will be described. In a certain light emission pattern, only the first light emitting unit 11 is caused to emit light. In another light emission pattern, only the second light emitting unit 12 is caused to emit light. In still another light emission pattern, the first light emitting unit 11 and the second light emitting unit 12 are caused to synchronously emit light. Examples in which the two light emitting units are caused to synchronously emit light can include an example of the “first predetermined condition” and an example of the “second predetermined condition (user operation mode)” in FIG. 5. In examples in which the mobile robot 100 includes light emitting units provided at three or more locations, the light emission patterns can be selected from among a large number of light emission patterns obtained from various combinations of the three or more light emitting units.

Conversely, examples in which the two light emitting units are caused to nonsynchronously emit light include an example of the “second predetermined condition (autonomous travel mode)” in FIG. 5. In the example of the “second predetermined condition (autonomous travel mode)” in FIG. 5, the first light emitting unit 11 and the second light emitting unit 12 are illustrated as hatched in opposite directions. However, this illustration is for convenience only, and only indicates that the two light emitting units are different in phase. However, this example can also be grasped as an example in which the timing to turn on the first light emitting unit 11 and the timing to turn off the second light emitting unit 12 are synchronized when the first light emitting unit 11 and the second light emitting unit 12 are caused to alternately emit light. In this manner, the control computer 101 can control light emission by the first light emitting unit 11 and the second light emitting unit 12 such that the light emission timings of the two light emitting units are alternated, that is, light emissions by the two light emitting units are alternated, as a certain light emission pattern.

The control computer 101 can present light emission with various rhythms to people in the surroundings, not only by alternating the light emission timings but also by causing the first light emitting unit 11 and the second light emitting unit 12 to emit light in different phases as a certain light emission pattern.

Further, light can be emitted in mutually complementary light emission patterns at a plurality of positions at which light is emitted synchronously. The mutually complementary light emission patterns can be patterns in which the first light emitting unit 11 and the second light emitting unit 12 are caused to emit light in a set of easily seeable colors, such as a pattern in which the first light emitting unit 11 and the second light emitting unit 12 are caused to emit light in mutually complementary colors.

The second light emitting unit 12 can include a plurality of individual light emitting portions disposed so as to surround the stick portion 131 at positions, the respective distances of which from the center position of the stick portion 131 in the horizontal direction are different from each other. That is, the second light emitting unit 12 can include individual light emitting portions disposed in two or three layers so as to surround the stick portion 131. This allows the second light emitting unit 12 alone to present various light emission patterns. In a scene in which an operation is to be prompted, in particular, the location of light emission can be moved from the inner individual light emitting portions toward the outer individual light emitting portions. The first light emitting unit 11 can similarly include a plurality of individual light emitting portions.

By using the various light emission patterns discussed above, the mobile robot 100 can indicate which of the predetermined conditions is met, which of the autonomous travel mode and the user operation mode the mobile robot 100 is in, etc. to people in the surroundings of the mobile robot 100 in a further easily seeable manner. The control computer 101 can also save power by suppressing light emission when not in an abnormal state, and inform people in the surroundings of the occurrence of a travel abnormality by emitting light in a conspicuous manner when in an abnormal state, for example.

The system control discussed above can also include control for stopping movement of the mobile robot 100 when it is determined that the travel state involves a travel abnormality. This makes it possible to stop movement of the mobile robot 100 when the travel state involves an abnormality, suppressing the occurrence of an undesirable event before such an event happens.

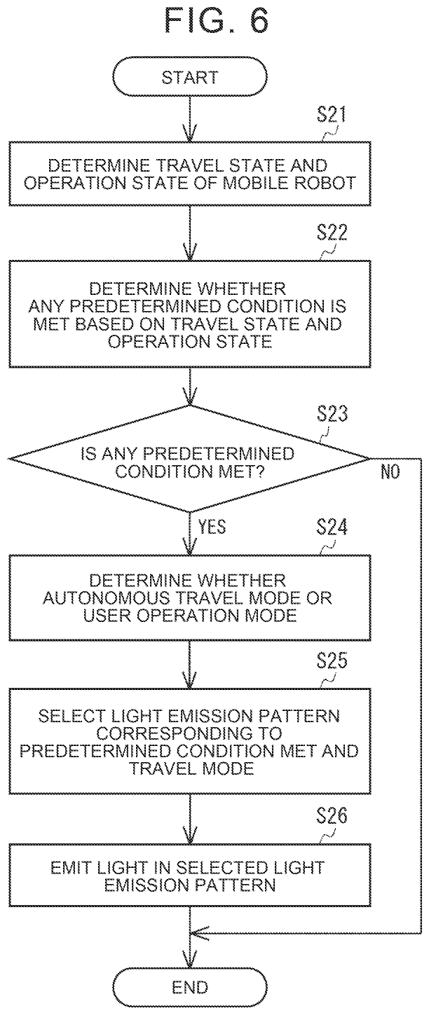

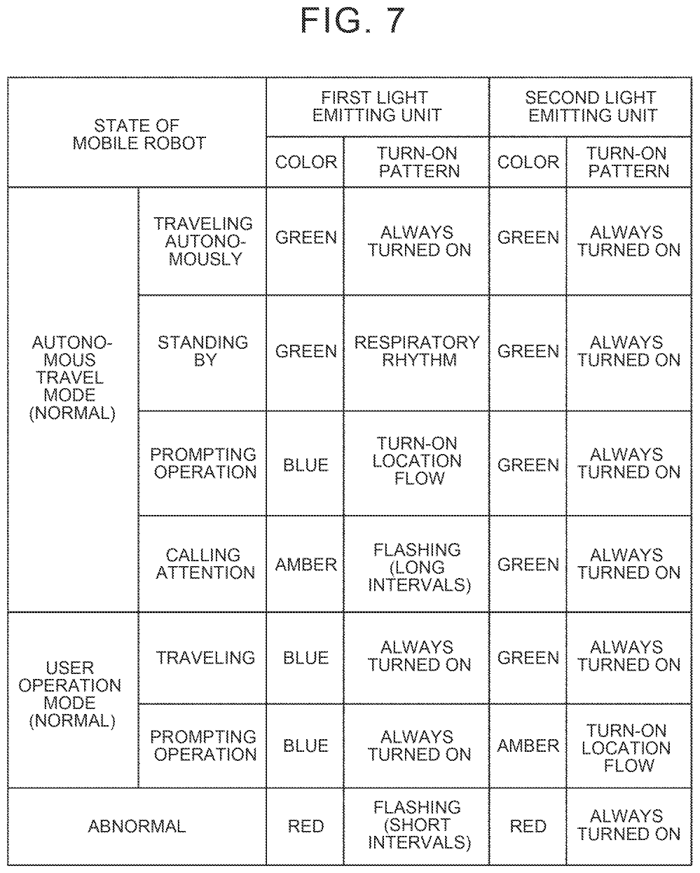

Next, another example of the light emission process that can be employed in the present embodiment will be described with reference to FIGS. 6 and 7. FIG. 6 is a flowchart illustrating another example of the light emission process executed by the mobile robot 100. FIG. 7 illustrates another example of the light emission patterns that can be implemented by the mobile robot 100.

At least one of the predetermined conditions employed can be a predetermined condition for recommending a direction operation (hereinafter simply referred to as a movement operation) by the user. In the following description, such a predetermined condition will be referred to as a recommendation condition. The recommendation condition refers to a condition that causes the need to prompt a movement operation by the user. The recommendation condition can refer to a condition that the mobile robot 100 is unable to move with no operation abnormality but with the occurrence of a travel abnormality such as bumping into a wall etc., for example. Here, the movement operation can be received not only from one or both of the operation unit 130 and the joystick device, for example, but also from an operation unit not included in the mobile robot 100.

By setting conditions in this manner, the mobile robot 100 can allow people around the mobile robot 100 to visually recognize a notification that recommends a movement operation by the user. The predetermined conditions employed can also include a plurality of recommendation conditions with different contents of recommended operations. This makes it possible to present the recommended contents to people in the surroundings according to the difference among the light emission patterns.

The recommendation conditions can also include a condition for recommending an operation to switch from the autonomous travel mode to the user operation mode, that is, a condition for recommending an operation that enables reception of a movement operation for the mobile robot 100 on the operation unit. This condition can be a condition for a situation in which it is determined that the mobile robot 100 falls into a state of needing treatment if the mobile robot 100 travels in the autonomous travel mode as the travel state indicates that there are so many people in the surroundings, for example. This allows the mobile robot 100 to cause people around the mobile robot 100 to visually recognize a notification that recommends switching to the user operation mode. If there is any staff member that can perform an operation in the people in the surroundings that have visually recognized the notification, the staff member can be prompted to switch to the user operation mode.

The recommendation conditions can also include a condition for recommending an operation to move the mobile robot 100 in a predetermined direction. Examples of this condition can include a condition that causes the need to detour as there are so many people around the mobile robot 100. A detouring route is preferably indicated as the predetermined direction, which is particularly advantageous when in the user operation mode.

In particular, when a recommendation condition that recommends an operation for movement in the predetermined direction is met, the control computer 101 preferably controls the first light emitting unit 11 and the second light emitting unit 12 so as to emit light so as to indicate the predetermined direction. For example, the light emission positions may be changed according to the predetermined direction. In this case, the operator is allowed to easily recognize the predetermined direction by controlling the light emitting unit that is close to the operation unit, such as the second light emitting unit 12 located around the joystick device, so as to indicate the predetermined direction. In this example, light is emitted so as to indicate the actual recommended movement direction, that is, the recommended orientation, and therefore the light emission positions are varied according to the present direction of the mobile robot 100, that is, according to the present orientation.

An example of the control discussed above will be described. The control computer 101 determines the travel state and the operation state of the mobile robot 100 (step S21), as in step S11 in FIG. 4. Next, the control computer 101 determines, based on the determined travel state and operation state, whether any of the predetermined conditions employed is met (step S22). When the result of the determination indicates NO, that is, when NO is taken in step S23, the process is ended.

When YES is taken in step S23, on the other hand, the control computer 101 determines whether the present mode is the autonomous travel mode or the user operation mode (step S24). In step S24, information that indicates whether the present mode is the autonomous travel mode or the user operation mode, of the operation state, can be obtained by referencing the present travel mode of the control computer 101.

Next, the control computer 101 selects a light emission pattern corresponding to the met predetermined condition and the present travel mode (step S25). Then, the control computer 101 controls the first light emitting unit 11 and the second light emitting unit 12 so as to emit light in the selected light emission pattern (step S26), and ends the process. Such a process can be repeatedly performed each time the results of detections by sensors that are used to determine the travel state and the operation state are varied or at predetermined intervals, for example.

In steps S25 and S26, the control computer 101 can select a light emission pattern and control light emission based on the correlation between the state and the light emission patterns indicated in FIG. 7, for example.

FIG. 7 indicates light emission patterns defined by the color of emitted light and the turn-on pattern for each of the first light emitting unit 11 and the second light emitting unit 12, for each of a case of “autonomous travel mode and normal”, a case of “user operation mode and normal”, and a case where either of the travel state and the operation state is “abnormal”. Here, the term “normal” indicates that both the travel state and the operation state are normal. In FIG. 7, as seen from the examples of the light emission patterns, the second light emitting unit 12 that is close to the operation unit 130 and the stick portion 131 mainly expresses the mode during normal times of the mobile robot 100 and an abnormality. The first light emitting unit 11 expresses the detailed state of the mobile robot 100 in the autonomous travel mode.

In FIG. 7, the case of “autonomous travel mode and normal” is expressed in the following four cases as the detailed operation state in the autonomous travel mode. That is, FIG. 7 indicates a case of “traveling autonomously” indicating a state in which the mobile robot 100 is in the middle of autonomous movement, a case of “standing by” indicating that the mobile robot 100 is under autonomous movement control but is stationary while standing by, a case of “prompting operation” indicating a scene in which the user is prompted to perform a certain operation, and a case of “calling attention” indicating a scene in which the mobile robot 100 is calling attention from the user or people in the surroundings. In this example, the case of “standing by” can indicate a case where the mobile robot 100 is being charged by a charger and a case where the mobile robot 100 is waiting for an elevator, for example. The case of “prompting operation” can indicate a case where the mobile robot 100 has arrived at a transport destination, for example. The case of “calling attention” can indicate a case where the elevation mechanism 140 is being elevated or lowered and a case where the mobile robot 100 is about to enter an intersection, for example. The case of “traveling autonomously” indicates the other cases where the mobile robot 100 is traveling autonomously.

Examples of the turn-on patterns in FIG. 7 include a “respiratory rhythm” in which the luminance of emitted light is varied according to a rhythm that is similar to human respiration and a “turn-on location flow” in which the turn-on location is caused to flow. In an example in which the turn-on location is caused to flow, the first light emitting unit 11 is turned on such that the turn-on location turns around the elevation mechanism 140, for example. For the second light emitting unit 12, it is meant that the turn-on location turns around the stick portion 131.

The examples of the colors and the turn-on patterns indicated in FIG. 7 are also applicable to the process example described with reference to FIGS. 4 and 5 as a matter of course.

As indicated for the case of “prompting operation” in FIG. 7, the light emission pattern correlated with the recommendation condition can be implemented by at least the second light emitting unit 12. With such a configuration, a notification that recommends a movement operation by the user can be indicated at the operation position or a position that is easily seeable from people in the surroundings of the operation position, and can be visually recognized by people around the mobile robot such as the operator.

While a single light emission pattern is used at the time of an abnormality in the example in FIG. 7, the light emission pattern for an abnormality can be changed between an abnormality in the autonomous travel mode and an abnormality in the user operation mode.

While not indicated in FIG. 7, the first light emitting unit 11 may emit light in a light emission pattern correlated with one of the predetermined conditions employed other than the recommendation condition. With such a configuration, a notification other than a notification that recommends a movement operation by the user can be visually recognized by people in the surroundings of the mobile robot at the operation position or a position that is different from the surroundings of the operation position, allowing such people to easily determine that the notification does not recommend an operation.

In the example described above, the transport system is mainly composed of a mobile robot 100 that includes a joystick device. However, it is only necessary that the control system to which the joystick device is applicable should execute system control for controlling a system that includes a mobile robot, such as the transport system, as discussed above. This system can also include a server that is connectable to the mobile robot 100 through wireless communication. This server provides the mobile robot 100 with information for autonomous movement. This server can be referred to as a higher-level management device, and is not limited to being composed of a single device but can be constructed as a system in which functions are distributed to a plurality of devices.

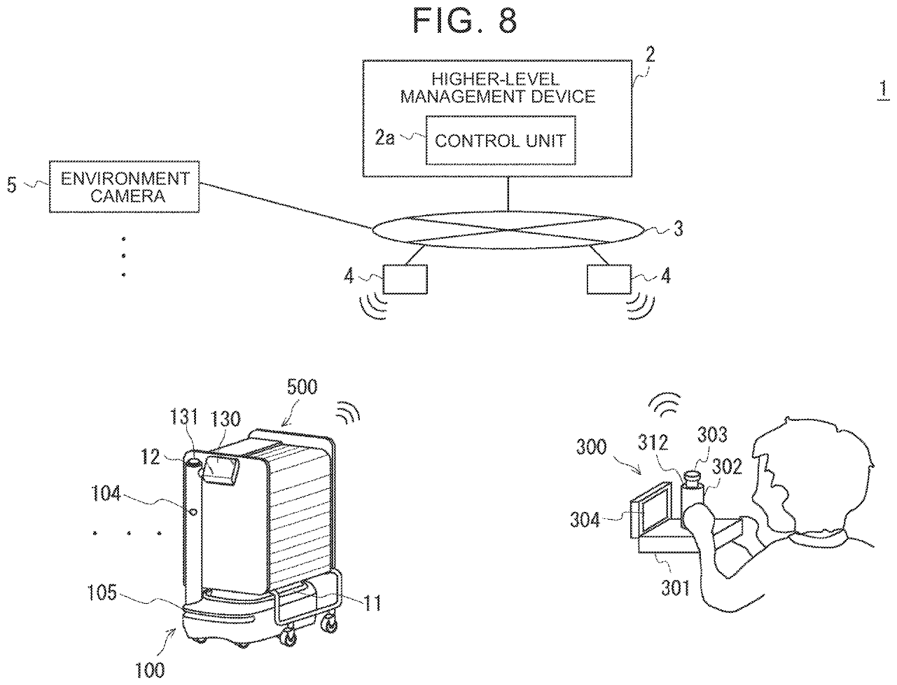

An example in which the transport system is configured to include the mobile robot 100 and the higher-level management device will be described below with reference to FIG. 8. FIG. 8 is a schematic diagram illustrating an example of the overall configuration of a transport system including the mobile robot 100.

As illustrated in FIG. 8, a transport system 1 includes a mobile robot 100, a higher-level management device 2, a network 3, a communication unit 4, an environment camera 5, and a user terminal device 300. The transport system 1 is a system that transports a transport object using the mobile robot 100, and includes a control system according to the present configuration example. In this example, the control system can indicate the mobile robot 100 and the higher-level management device 2, or indicate constituent elements of a control system included in the mobile robot 100 and the higher-level management device 2.

The mobile robot 100 and the user terminal device 300 are connected to the higher-level management device 2 via the communication unit 4 and the network 3. The network 3 is a wired or wireless local area network (LAN) or wide area network (WAN). Further, the higher-level management device 2 and the environment camera 5 are connected to the network 3 through a wire or wirelessly. As can be seen from such a configuration, the mobile robot 100, the higher-level management device 2, and the environment camera 5 each include a communication unit. The communication unit 4 is a wireless LAN unit, for example, installed in each environment. The communication unit 4 may be a general-purpose communication device such as a Wi-Fi (registered trademark) router, for example.

The higher-level management device 2 is a device that is connectable to the mobile robot 100 through wireless communication, and is a management system that manages a plurality of mobile robots 100, and can include a control unit 2a that performs control. The control unit 2a can be implemented by an integrated circuit, for example, and can be implemented by a processor such as an MPU or a CPU, a working memory, a non-volatile storage device, etc., for example. The function of the control unit 2a can be achieved by the storage device storing a control program to be executed by the processor and the processor loading the program into the working memory and executing the program. The control unit 2a can be referred to as a control computer.

The transport system I can efficiently control the mobile robots 100 in a predetermined facility while autonomously moving the mobile robots 100 in the autonomous travel mode or while moving the mobile robots 100 based on user operations in the user operation mode. The facility can indicate various types of facilities such as medical and welfare facilities such as hospitals, rehabilitation centers, nursing care facilities, and residential facilities for the elderly, commercial facilities such as hotels, restaurants, office buildings, event sites, and shopping malls, and other complex facilities.

In order to efficiently perform such control, a plurality of environment cameras 5 can be installed in the facility. The environment cameras 5 acquire images of a range in which people and the mobile robots 100 move, and output image data that indicate such images. The image data may be still image data or moving image data. When the image data are still image data, the still image data can be obtained at capturing intervals. In the transport system 1, the images acquired by the environment cameras 5 and information based on such images are collected by the higher-level management device 2. For images that are used to control the mobile robots 100, images acquired by the environment cameras 5 etc. may be directly transmitted to the mobile robots 100, or may be transmitted to the user terminal device 300, either via the higher-level management device 2 or directly, in the user operation mode. The environment cameras 5 can be provided as monitoring cameras in passages in the facility and at entrances and exits.

The higher-level management device 2 can determine a mobile robot 100 that executes a transport task for each transport request, and transmit an operation instruction for executing the transport task to the determined mobile robot 100. The mobile robot 100 can autonomously move from a transport origin to arrive at a transport destination according to the operation instruction. In this event, a transport route may be determined by any method.

For example, the higher-level management device 2 assigns a transport task to a mobile robot 100 at or in the vicinity of the transport origin. Alternatively, the higher-level management device 2 assigns a transport task to a mobile robot 100 heading for the transport origin or the vicinity of the transport origin. The mobile robot 100 to which a task has been assigned moves to the transport origin to pick up a transport object.

The user terminal device 300 is an example of the remote operation device discussed above that remotely operates the mobile robot 100, either via the higher-level management device 2 or directly, in the user operation mode. To that end, the user terminal device 300 can be equipped with a communication function, and can include a display unit 304. When the user terminal device 300 is a device that remotely operates the mobile robot 100 via the higher-level management device 2, the user terminal device 300 is also considered to correspond to a remote operation device for the higher-level management device 2. Examples of the user terminal device 300 include various types of terminal devices such as tablet computers and smartphones. The user terminal device 300 can receive an operation to switch between the user operation mode and the autonomous travel mode. When this switching operation is performed, the user terminal device 300 can switch the mode of the mobile robot 100 via the higher-level management device 2.

In the configuration example in FIG. 1, the joystick device is included in the mobile robot 100 to allow people in the surroundings to visually recognize the state of the mobile robot 100. On the contrary, the joystick device can also be included in the user terminal device 300. That is, the user terminal device 300 can include not only a body portion 301 but also a stick portion 302 and a button 303 as a part of the joystick device. This joystick device is a device that is operated to move the mobile robot 100 in a direction intended by the user when in the user operation mode. A direction operation can be received by tilting the stick portion 302 in a direction in which it is desired to move the mobile robot 100.

The joystick device can also be controlled so as to perform a switching operation to switch between the autonomous travel mode and the user operation mode by depressing the button 303 downward. Alternatively, the joystick device can be controlled so as to perform a determination operation by depressing the button 303 downward. The button 303 can also be configured to function as an emergency stop button by depressing the button 303 downward for a predetermined period. When the button 303 is configured to be able to receive two or more of the switching operation, the determination operation, and the emergency stop operation, that is, when a plurality of operation contents are assigned to the button 303, respective predetermined periods may be set to the corresponding operations.

When the user terminal device 300 includes a joystick device, the user can perform similar operations, even if the mobile robot 100 does not include a joystick device. When the user terminal device 300 includes a joystick device, further, a light emitting unit (hereinafter “terminal-side second light emitting unit 312”) that is similar to the second light emitting unit 12 can be disposed at or around the joystick device to perform light emission control that is similar to the second light emitting unit 12. While the terminal-side second light emitting unit 312 is disposed on the upper surface of the stick portion 302 so as to have a light emission region around the button 303 in the example in FIG. 8, this is not limiting, and the terminal-side second light emitting unit 312 may be disposed at or around the joystick device. The shape of the light emission region of the terminal-side second light emitting unit 312 is also not limited to that illustrated in the drawing. For example, the terminal-side second light emitting unit 312 can indicate a light emission pattern as a display image using the display unit 304. The mobile robot 100 can also include a button such as the button 303 on the upper surface etc. of the stick portion 131. In the configuration in which the transport system 1 manages a plurality of mobile robots 100, a mobile robot 100 to be remotely controlled can be selected from the user terminal device 300 when in the user operation mode.

As exemplified in FIG. 8, a joystick device can be provided in both the mobile robot 100 and the user terminal device 300. In that case, while the second light emitting unit can be provided at or around one of the joystick devices, the second light emitting unit may be provided at or around both the joystick devices.

The display unit 304 can be caused to display an image indicated by image data received from the camera 104 in the mobile robot 100, and an image indicated by image data received from the environment camera 5 located around the mobile robot 100. This allows the user to operate the mobile robot 100 using the stick portion 302 and the button 303.

The user terminal device 300 can be caused to function as a device that makes a transport request etc. to the higher-level management device 2. This transport request can include information that indicates a transport object.

In the transport system 1 configured as discussed above, the higher-level management device 2 preferably outputs a control signal for light emission control, whether a joystick device is included in the mobile robot 100, included in the user terminal device 300, or included in both. When the higher-level management device 2 outputs this control signal, the control unit 2a can output the control signal. In that case, the determination of the predetermined condition for light emission control may be made by the control unit 2a of the higher-level management device 2. However, the determination may be made by the control computer 101 and the result of the determination may be delivered to the higher-level management device 2, or the determination may be made by a control unit included in the joystick device and the result of the determination may be delivered to the higher-level management device 2.

Alternatively, the transport system 1 can be configured such that a control unit (not illustrated) included in a joystick device outputs a control signal for light emission control. Here, when a joystick device is included in one of the mobile robot 100 and the user terminal device 300, the control unit of the joystick device can output a control signal. When a joystick device is included in both, the control unit of either joystick device may output a control signal, or the control units of both the joystick devices may output a control signal to the light emitting unit provided in or around the device itself.

Alternatively, in the transport system 1 configured as discussed above, the control unit (exemplified by the control computer 101) included in the mobile robot 100 can be configured to output a control signal for light emission control. In that case, the determination of the predetermined condition for light emission control may be made by the control computer 101. However, the determination may be made by the control unit 2a of the higher-level management device 2 or the control unit included in the joystick device, and the result of the determination may be delivered to the mobile robot 100. A transport system can be configured not to include the higher-level management device 2, instead of the transport system 1. In the case of such a configuration, the control unit of the mobile robot 100 exemplified by the control computer 101 can output a control signal for the determination of the predetermined condition and light emission control. However, the control unit included in the joystick device can also output a control signal for the determination of the predetermined condition and light emission control, for example.

Further, when at least the higher-level management device 2 cannot communicate with the mobile robot 100, or in a configuration in which the higher-level management device 2 does not acquire the state of the mobile robot 100 through communication, the control system in the transport system 1 can perform the following control. That is, when the higher-level management device 2 cannot communicate with the mobile robot 100, or in a configuration in which the higher-level management device 2 does not acquire the state of the mobile robot 100 through communication, the control system can determine the state or the travel mode of the mobile robot 100 from a light emission pattern indicated by an image of the mobile robot 100 captured by the environment camera 5 based on such an image. Here, the travel mode indicates whether the mobile robot 100 is in the autonomous travel mode or the user operation mode. This image can be an image captured by a camera of another mobile robot included in the transport system 1, in place of or in addition to the image captured by the environment camera 5. While the description about the terminal-side second light emitting unit 312 is omitted here, the control system can also determine the state or the travel mode of the mobile robot 100 with reference to the light emission pattern of the terminal-side second light emitting unit 312. In that case, the control system makes the determination also with reference to an image of the user terminal device 300 captured by a camera such as the environment camera 5.

The mobile robot 100, or the mobile robot 100 and the user terminal device 300 operating the mobile robot 100, can present various light emission patterns according to whether the predetermined conditions are met etc. as exemplified in FIGS. 5 and 7, and the higher-level management device 2 can determine the present state, mode, etc. of the mobile robot 100 from the present light emission pattern. While a single light emission pattern is used at the time of an abnormality in the example in FIG. 7, the light emission pattern for an abnormality can be changed between an abnormality in the autonomous travel mode and an abnormality in the user operation mode, which allows the higher-level management device 2 to determine whether the mobile robot 100 is in the autonomous travel mode or the user operation mode even at the time of an abnormality.

When the control system of the transport system 1 is configured in this manner, the higher-level management device 2 can determine whether the mobile robot 100 meets the predetermined conditions and determine the travel mode when communicate between the mobile robot 100 and the higher-level management device 2 is disabled or when the higher-level management device 2 is configured not to acquire the state of the mobile robot 100 through communication.

This allows the higher-level management device 2 to provide an instruction to a certain user to move the mobile robot 100, collect and inspect the mobile robot 100, etc. through manual work when the mobile robot 100 that cannot communicate meets a certain predetermined condition and is in the autonomous travel mode, for example. Then, the user can perform the work according to the instruction. When the mobile robot 100 that cannot communicate meets a certain predetermined condition that causes the mobile robot 100 to stand by and is in the user operation mode, meanwhile, the mobile robot 100 is unattended with the operator away from the mobile robot 100, for example. Hence, in such a case, the higher-level management device 2 can also notify the operator to return to the position of the mobile robot 100. A similar effect is achieved also in a configuration in which the higher-level management device 2 does not acquire the state of the mobile robot 100 through communication.

Here, a method for the mobile robot 100 to determine a travel abnormality will be described. Also in the transport system 1, the mobile robot 100 can determine a travel abnormality in the method described with reference to FIG. 1 etc.

In other determination methods, the mobile robot 100 can determine a travel abnormality from an image captured by the environment camera 5 and transmitted to the mobile robot 100, either directly or via the higher-level management device 2. Here, an image captured by a camera of another mobile robot, instead of the environment camera 5, can also be used for the determination. That is, the control computer 101 can determine a travel abnormality based on an image captured by a camera installed in a facility in which the mobile robot 100 is in operation, exemplified by the environment camera 5 or a camera of another mobile robot. The control unit 2a of the higher-level management device 2 can also make such a determination. In that case, information that indicates the travel state is preferably transmitted to the mobile robot 100 in advance in preparation for interruption of wireless communication with the higher-level management device 2.

Also in a configuration in which the mobile robot 100 acquires information that indicates the travel state from the higher-level management device 2, the mobile robot 100 can acquire such information before communication with the higher-level management device 2 is interrupted. Hence, the mobile robot 100 can perform light emission control according to information obtained before communication is interrupted.

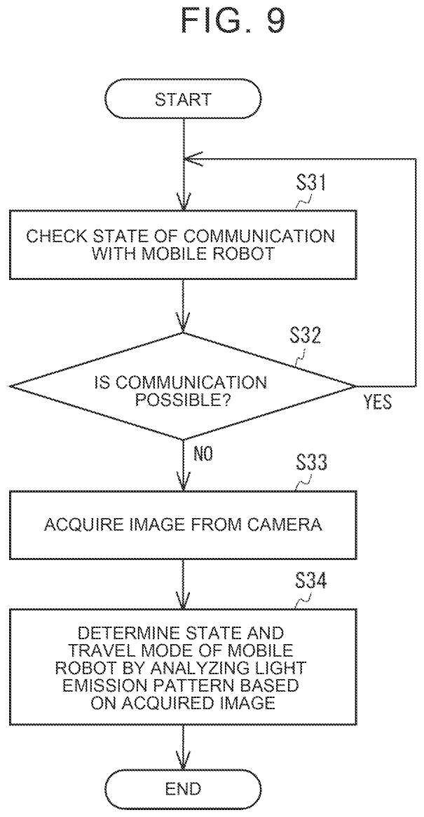

Next, an example of a process by the higher-level management device 2 in the transport system 1 will be described with reference to FIG. 9. FIG. 9 is a flowchart illustrating an example of a process by the higher-level management device 2 in the transport system 1 in FIG. 8.

In the higher-level management device 2, first, the control unit 2a monitors a communication unit (not illustrated) to check the state of communication with the mobile robot 100 (step S31), and determines whether communication is possible (step S32). When it is determined that communication with the mobile robot 100 is possible, the control unit 2a returns to step S31, and continues monitoring. When it is determined that communication with the mobile robot 100 is not possible, the control unit 2a acquires an image from a camera (step S33). This camera can be the environment camera 5, a camera included in another mobile robot traveling near the location at which communication with the mobile robot 100 is interrupted, or both.

Next, the control unit 2a determines the state or the travel mode of the mobile robot 100 by analyzing the light emission pattern of the mobile robot 100, or the light emission pattern of at least one of the mobile robot 100 and the user terminal device 300 operating the mobile robot 100, based on the acquired image (step S34), and ends the process. As a matter of course, step S34 can include determining which of the predetermined conditions is met. The control unit 2a can be configured to obtain the state or the travel mode of the mobile robot 100 from an image using a learning model obtained through machine learning when analyzing the light emission pattern and making the determination for the mobile robot 100.

In this manner, in the control system of the transport system 1, even when communication between the mobile robot 100 and the higher-level management device 2 is not possible, the higher-level management device 2 can determine whether the mobile robot 100 is in the autonomous travel mode or the user operation mode or which of the predetermined conditions is met, as presented by the light emission pattern by the mobile robot 100 or the mobile robot 100 and the user terminal device 300 operating the mobile robot 100.

In a configuration in which the mobile robot 100 or the user terminal device 300 can express the operation state using the light emission pattern, that is, in a configuration in which the predetermined condition includes a condition about the operation state, the system control can include control for determining the operation state of the mobile robot 100 from the light emission pattern indicated by the image. This allows providing an instruction to the user to collect and inspect the mobile robot 100 etc., and allows the user to perform such work according to the instruction, when the mobile robot 100 that cannot communicate involves an operation abnormality, for example.

Even in a configuration in which the transport system does not include the higher-level management device 2, the transport system can include the environment camera 5 that can wirelessly communicate with the mobile robot 100. Also in such a configuration, the state, travel mode, etc. of the mobile robot 100 can be similarly determined from an image obtained from the environment camera 5. As a matter of course, if the mobile robot 100 can communicate with a different mobile robot, the state, travel mode, etc. of the mobile robot 100 can be determined based on an image acquired by a camera mounted on the different mobile robot.

As discussed above, the joystick device is not limited to being included in the mobile robot 100, and can be included in a remote operation device that remotely operates the mobile robot 100 as exemplified by the user terminal device 300.

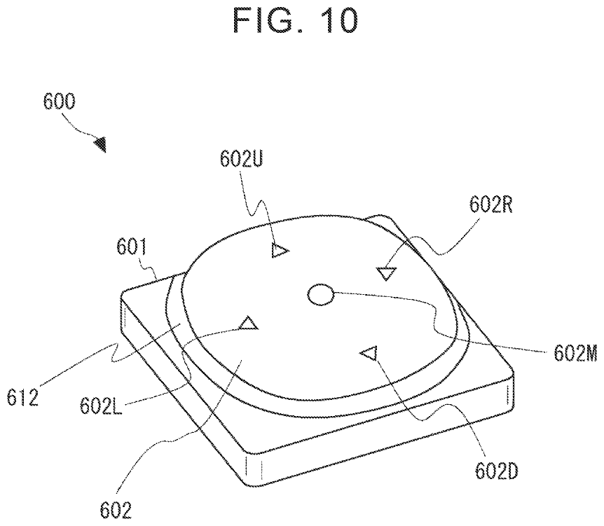

While the operation device according to the present embodiment is a joystick device in the described example, the operation device according to the present embodiment is not limited to a joystick device, and it is only necessary that the operation device should include an operation unit that receives an operation including a direction operation for the mobile robot and a light emitting unit. An example of such an operation device will be described with reference to FIG. 10. FIG. 10 is a perspective view illustrating another example of the configuration of an operation device that can be used to operate the mobile robot 100 according to the present embodiment.

An operation device 600 illustrated in FIG. 10 can include a body portion 601 and an operation portion 602, and can be included in the user terminal device 300 in place of the joystick device included in the user terminal device 300 as the stick portion 302 etc., or be used in place of the user terminal device 300.

The operation portion 602 can be a touch sensor, or include a touch sensor. As exemplified in FIG. 10, the touch sensor can be marked with arrows 602U, 602D, 602R, and 602L that indicate upward (forward), downward (rearward), rightward, and leftward operation directions, respectively, and be marked with a mark 602M that indicates a touch position for performing a mode switching operation etc. Although not illustrated in FIG. 10, placing character information such as “up”, “down”, “right”, and “left” allows the user to see the movement direction, no matter in what direction the user faces the operation device 600. The operation portion 602 can receive a movement operation for the mobile robot 100 when the user performs a slide operation using his/her finger on the touch sensor.

The operation device 600 can include, in a portion of the body portion 601 positioned around the operation portion 602, a second light emitting unit 612 that can be subjected to light emission control, as with the second light emitting unit 12 and the terminal-side second light emitting unit 312. The second light emitting unit 612 can also be included at the outer peripheral end portion of the operation portion 602. The second light emitting unit 612 may have any shape, size, and position, as with the second light emitting unit 12 and the terminal-side second light emitting unit 312.

The operation device 600 described here can be provided in place of the joystick device composed of the stick portion 131 etc. included in the mobile robot 100.

The embodiment discussed above has been described on the assumption that the operation device such as the joystick device is a device that is used to operate the mobile robot. However, the present embodiment may take the form of a control method of performing the various control discussed above, or take the form of a program for performing such control. Further, the present embodiment is applicable not only to mobile robots but also to other types of operation target devices. In that case, the present embodiment achieves the effect of allowing people in the surroundings to visually recognize the position of the operation target device.

That is, an operation device such as a joystick device can include an operation unit that receives an operation including a direction operation for the operation target device, and a light emitting unit provided around the operation unit. Such an operation device can indicate the position of the operation target device to people in the surroundings in an easily seeable manner, and enables an operation to be performed immediately using the operation device when such an operation is necessary, for example.

The various examples described above in which a mobile robot is operated using an operation device such as a joystick device are also applicable to operation target devices other than the mobile robot. For example, the light emitting unit can be caused to emit light in a light emission pattern that indicates the state of the operation target device, which allows people in the surroundings to visually recognize the state of the operation target device. The light emitting unit can include a plurality of individual light emitting portions disposed so as to surround the operation unit at positions, the respective distances of which from the center position of the operation unit in the horizontal direction are different from each other. The light emitting unit can be caused to emit light in a light emission pattern that indicates the content of an operation received by the operation device. The light emitting unit can be caused to emit light in a light emission pattern that indicates the content of a recommended operation, among operations that can be received by the operation device. The light emitting unit can be caused to emit light in a light emission pattern that indicates the state of the operation target device. The operation device can include a button that receives a depression operation to switch the operation mode of the operation target device. When the operation device is a joystick device, the button can be provided at the distal end of the stick member, or provided at a position depressed by pushing in the stick member. When the operation target device is capable of autonomous operation and operation based on user operations, this button can be a button that receives a depression operation to switch between an autonomous operation mode in which autonomous operation is performed and a user operation mode in which operations on the operation unit are received. The operation device can be included in the operation target device, or can be provided as a remote operation device for the operation target device.

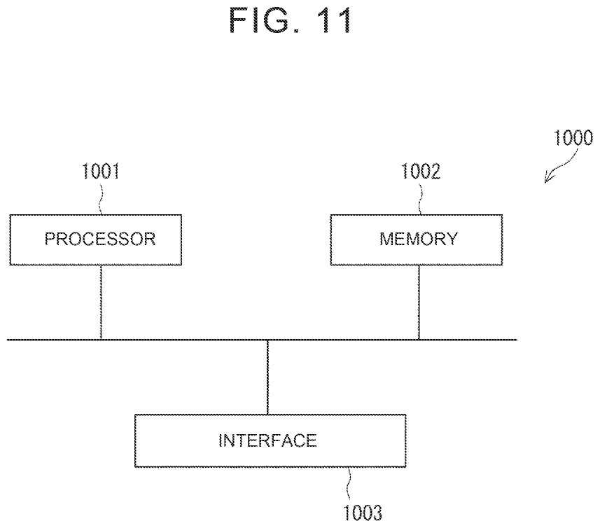

The various devices discussed above, such as the control computer 101 of the mobile robot 100, the higher-level management device 2, the user terminal device 300, and the operation target device according to the embodiment discussed above can include the following hardware configuration, for example. Alternatively, the operation device included in the mobile robot 100, the user terminal device 300, the operation target device, etc. can include the following hardware configuration. FIG. 11 illustrates an example of the hardware configuration of an apparatus.

An apparatus 1000 illustrated in FIG. 11 can include a processor 1001, a memory 1002, and an interface 1003. The interface 1003 can include a communication interface and an interface with a drive unit, a sensor, input and output devices, etc., for example, that are necessary for the apparatus.

The processor 1001 may be an MPU, a CPU, a graphics processing unit (GPU), etc., for example. The processor 1001 may include a plurality of processors. The memory 1002 is composed of a combination of a volatile memory and a non-volatile memory, for example. The functions of each device are implemented by the processor 1001 reading a program stored in the memory 1002 and executing the program while exchanging necessary information via the interface 1003.

The program discussed above includes a group of instructions (or software codes) for causing a computer to perform one or more of the functions described in relation to the embodiment when loaded into the computer. The program may be stored in a non-transitory computer-readable medium or a tangible storage medium. Examples of the computer-readable medium or the tangible storage medium include, but are not limited to, a random-access memory (RAM), a read-only memory (ROM), a flash memory, a solid-state drive (SSD), and other memory technologies, a compact disc read-only memory (CD-ROM), a digital versatile disc (DVD), a Blu-ray (registered trademark) disc, and other optical disc storages, and a magnetic cassette, a magnetic tape, a magnetic disk storage, and other magnetic storage devices. The program may be transmitted on a transitory computer-readable medium or a communication medium. Examples of the transitory computer-readable medium or the communication medium include, but are not limited to, an electrical, optical, acoustic, or other forms of propagating signals.

The present disclosure is not limited to the above embodiment, and can be modified as appropriate without departing from the spirit and scope of the present disclosure.

What is claimed is:

1. An operation device, comprising:
an operation unit configured to receive an operation including a direction operation for a mobile robot; and
a light emitting unit configured to emit light in a light emission pattern that indicates a state of the mobile robot.

2. The operation device according to claim 1, wherein the light emitting unit is provided around the operation unit.

3. The operation device according to claim 1, wherein the operation device is a joystick device that includes a stick member as at least a part of the operation unit.

4. The operation device according to claim 2, wherein the operation device is a joystick device that includes a stick member as at least a part of the operation unit.

5. The operation device according to claim 3, wherein the light emitting unit is provided at a distal end of the stick member.

6. The operation device according to claim 1, wherein the operation device is included in the mobile robot.

7. A mobile robot comprising the operation device according to claim 1, wherein the mobile robot is configured to receive an operation to move the mobile robot using the operation unit.
